(19) United States
(12) Patent Application Publication
(10) Pub. No.: US 2013/0129517 A1
(43) Pub. Date: May 23, 2013

(54) AEROGENERATOR BLADE AND MANUFACTURING METHOD THEREOF

(71) Applicants: Phillips Antonio Da Costa Lemos, Sorocaba (BR); Hely Ricardo Savii, Sorocaba (BR); Leo Ossanai, Sorocaba (BR); Tomaz Schmidt Cavalcante, Sorocaba (BR); Bruno Dal Medico Hirsch, Sorocaba (BR); Lúcio Corrêa Oliveira De Oliveira, Sorocaba (BR)

(72) Inventors: Phillips Antonio Da Costa Lemos, Sorocaba (BR); Hely Ricardo Savii, Sorocaba (BR); Leo Ossanai, Sorocaba (BR); Tomaz Schmidt Cavalcante, Sorocaba (BR); Bruno Dal Medico Hirsch, Sorocaba (BR); Lúcio Corrêa Oliveira De Oliveira, Sorocaba (BR)

(73) Assignee: TECSIS TECNOLOGIA E SISTEMAS AVANCADOS S.A., Sorocaba (BR)

(21) Appl. No.: 13/698,323

(22) PCT Filed: May 20, 2010
(86) PCT No.: PCT/IB10/52256

§ 371 Date: Feb. 4, 2013

(51) Int. Cl. F03D 1/06

(52) U.S. Cl. CPC F03D 1/06
USPC 416/226; 29/889.7

(57) ABSTRACT

Aerogenerator blade and method of manufacturing thereof, the aerogenerator blade comprising an intrados shell, an extrados shell and a structural beam, the structural beam comprising a root spar, a transitional spar and a box spar, wherein the root spar has a substantially circular cross section configured to support the connection of the blade to the aerogenerator hub; the transitional spar tapers from the root spar towards the box spar; and the box spar tapers towards the blade tip; and wherein the aerogenerator blade is characterized by comprising: a first section of the structural beam including at least a root spar portion, a transitional spar portion and a box spar portion, the portions forming a first integral structural beam section; a second section including at least the counterparts of the root spar portion, the transitional spar portion and the box spar portion, said counterpart portions forming a second integral structural beam section; and wherein the first section of the structural beam is joined with the second section of the structural beam, forming the structural beam; and the intrados shell and the extrados shell are assembled on the structural beam.

### TECHNICAL FIELD

This invention relates to an aerogenerator blade and method of manufacturing thereof, and more particularly to a structural beam used in the blade.

### BACKGROUND ART

Wind power is frequently produced by large generators comprising a vertical structure (e.g. tower) on top of which is placed at least one horizontal axis wind turbine that includes one, two, three or multiple rotor blades. Wind power generators, or simply ‘aerogenerators’, are designed to exploit wind energy existing at a particular location and therefore vary in height, control system, number of blades, blade orientation, shape and materials.

Currently, blades of 20 to 40 meters in length for an aerogenerator rated power of about 0.5 MW to 1.5 MW are very common; but there is an increasing attention spent on larger aerogenerator blades, which nowadays are reaching about 80 meters high with 3.0 MW rated power. Nevertheless, both medium sized blades and larger blades still have many design and manufacturing problems.

In general, an aerogenerator blade commonly has an airfoil profile with a root region, a tip region, a leading edge, a trailing edge, a pressure side (intrados shell) and a suction side (extrados shell).

During operation of the aerogenerator, the blades are subject to various dynamic and static loads. Therefore, a typical blade includes some structural members, usually referred to as spars. A typical blade usually includes one spar cap in each blade shell half and one shear web connecting the spar caps, resulting in a typical ‘I-beam’ configuration. Another typical configuration is the box spar wherein the spar caps are connected by two shear webs.

Spar caps and shear webs may include one or more layers of any suitable materials that enable spar caps and/or shear webs to function as structural members, such as, but not limited to, metals, plastics, wood, and/or fibers, such as, but not limited to, glass fiber, carbon fiber, and/or aramid fiber. The layers may include sandwich or composite structures, as well as include one or more core materials, such as, but not limited to, balsa, foams, metals, and/or fabrics.

### DISCLOSURE OF INVENTION

### Technical Problem

One particular technical problem regarding spar caps and shear webs is that during operation of the aerogenerator, the blades are subject to various dynamic and static strains. The tip is usually considered to be the most fragile part of blade; however, as the root of the blade transmits the main loads from the blade to the hub, the root region is also subject to considerable stresses due to the aforementioned loads. Hence, as the structural members usually have a limited length, the blade root wall must be manufactured to support and distribute the aforementioned loads along the root circumference. This usually requires reinforcement of the blade root wall, what increases the overall costs of the blade. In order to address this and other problems, the German patent application published under no. DE102007036917A1 (HAFNER, Edzard) suggests a structural beam covering a substantial length span of the blade, from the blade root to the blade tip, further including pre-stressed clamping members for the distribution of the stresses along the blade span length. Nevertheless, the aforementioned document does not provide any hint on how to efficiently manufacture the structural beam in a manner which allows an effective integration with the aerogenerator blade shells and blade root, as well as an does not provide a hint about the best structural design for said structural beam and respective blade.

### Technical Solution

To overcome the drawbacks and problems described above and other disadvantages not mentioned herein, in accordance with the purposes of the invention, as described herein, one basic aspect of the present invention is directed to an aerogenerator blade comprising an intrados shell, an extrados shell and a structural beam, the structural beam comprising a root spar, a transitional spar and a box spar, wherein a) the root spar has a substantially circular cross section configured to support the connection of the blade to the aerogenerator hub; b) the transitional spar tapers from the root spar towards the box spar; and c) the box spar tapers towards the blade tip; and wherein the aerogenerator blade is characterized by comprising: a first section of the structural beam including at least a root spar portion, a transitional spar portion and a box spar portion, the portions forming a first integral structural beam section; a second section including at least the counterparts of the root spar portion, the transitional spar portion and the box spar portion, said counterpart portions forming a second integral structural beam section; and wherein the first section of the structural beam is joined with the second section of the structural beam, forming the structural beam; and the intrados shell and the extrados shell are assembled on the structural beam.

Another aspect of the invention is directed to a method of manufacturing an aerogenerator blade, the blade comprising an intrados shell, an extrados shell and a structural beam, the structural beam comprising a root spar, a transitional spar and a box spar, wherein a) the root spar has a substantially circular cross section configured to support the connection of the blade to the aerogenerator hub; b) the transitional spar tapers from the root spar towards the box spar; and c) the box spar tapers towards the blade tip; wherein the method is characterized by comprising: manufacturing a first section of the structural beam in a first mould, the first section including at least a root spar portion, a transitional spar portion and a box spar portion, the portions forming a first integral structural beam section; manufacturing a second section of the structural beam in a second mould, the second section including at least the counterparts of the root spar portion, the transitional spar portion and the box spar portion, said counterpart portions forming a second integral structural beam section; joining the first section of the structural beam to the second section of the structural beam, forming the structural beam; assembling the intrados shell and the extrados shell on the structural beam.

### Advantageous Effects

The present invention has several advantages over the prior art.

For instance, with the structural beam having two sections, it is possible to manufacture the sections in two moulds, which are used to join these two sections, thus obtaining a structural beam with an enhanced quality and structural behavior. As each section comprises a root spar portion, a transitional spar portion and a box spar portion, with the root spar portion being an integral part of the structural beam, the need for additional reinforcement of the blade root becomes unnecessary or is at least substantially reduced. This allows assembling the intrados shell and the extrados shell directly on the structural beam for obtaining the final aerodynamic profile; the intrados shell and the extrados shell having now substantially less material and components, and becoming a complement of the structural beam and not the other way around as in the prior art. The intrados and extrados shell may, for instance, cover only the transitional spar and the box spar, leaving the root spar of the structural beam uncovered.

Furthermore, in the prior art, the common process is manufacturing in a first step the intrados shell and extrados shells, each in a separate mold while the spars caps are being manufactured separately in other molds. However, during this first step the spar caps must be inserted into the intrados and extrados shells prior to finishing the manufacturing of said shells. Therefore, only when this first step is finished, a second step may be started, in which the shear webs may be glued over the spar caps and shells. Then, in a third step the two shell molds may be joined to form the shape of the blade, which still has the problem of needing a separate blade root connection an/or root reinforcement.

Alternatively, in the case of a blade with a box spar, the spar caps are a part of the box spar, therefore, it is not necessary to insert the spar caps in the intrados and the extrados shells during manufacturing of the shells. Nevertheless, it is still necessary an additional step for manufacturing the blade root and the reinforcement thereof. Conversely, according to the present invention, while the structural beam sections are being manufactured in their respective molds, the blade shells may at the same time be manufactured in separate molds; however, in this case, as soon as the structural beam is finished, it is possible to assemble the blade shells on the structural beam, which results in the final shape of the blade already including the blade root, wherein the need of an special reinforcement is significantly reduced or even eliminated. Hence, the total manufacturing cycle time is surprisingly reduced.

### DESCRIPTION OF DRAWINGS

The accompanying drawings are not necessarily drawn on scale. In the drawings, some identical or nearly identical components that are illustrated in various figures may be represented by a corresponding numeral. For purposes of clarity, not every component may be labelled in every drawing.

FIG. 1 illustrates one exemplary aerogenerator blade .

FIG. 2 illustrates an exemplary finished aerogenerator blade according to the present invention viewed from a perspective of the tip leading edge.

FIG. 3 illustrates a partially exploded view of an exemplary aerogenerator blade according to the present invention viewed from a perspective of the tip leading edge, in which the structural beam sections are joined and the intrados and extrados shells are exploded.

FIG. 4 illustrates an exploded view of an exemplary aerogenerator blade according to the present invention viewed from a perspective of the tip leading edge, with the structural beam sections and the intrados and extrados shells exploded.

FIG. 5 illustrates an exemplary finished aerogenerator blade according to the present invention viewed from a perspective of the root trailing edge.

FIG. 6 illustrates a partially exploded view of an exemplary aerogenerator blade according the present invention viewed from a perspective of the root trailing edge, in which the structural beam sections are joined and the intrados and extrados shells are exploded.

FIG. 7 illustrates an exploded view of an exemplary aerogenerator blade according to the present invention viewed from a perspective of the root trailing edge, with the structural beam sections and the intrados and extrados shells exploded.

### MODE FOR INVENTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of ‘including’, ‘comprising’, ‘having’, ‘containing’ or ‘involving’, and variations thereof herein, is meant to encompass the items listed thereafter and equivalents thereof as well as additional items.

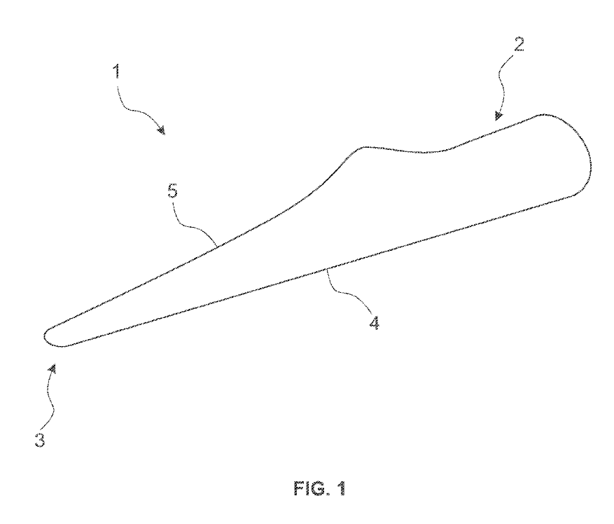

FIG. 1 illustrates one exemplary aerogenerator blade (1). An aerogenerator blade (1) commonly has an airfoil profile with a root region (2), a tip region (3), a leading edge (4) and a trailing edge (5). A typical aerogenerator blade further includes a plurality of other components that are not shown in the figures for purposes of clarity, such as a lightning protection system, a plurality of studs or other types of fasteners for connecting the blade root end to the aerogenerator hub, as well as other components varying according to the type of blade. These components and their variations are well know in the prior art.

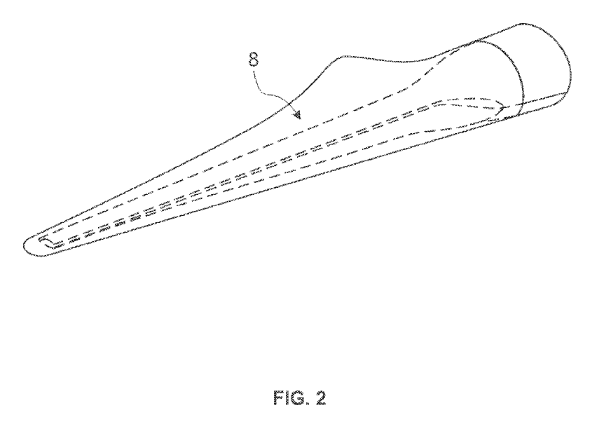

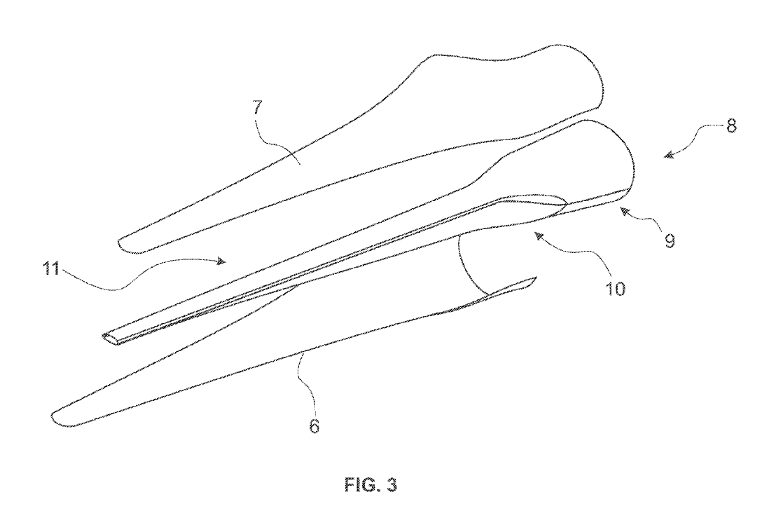

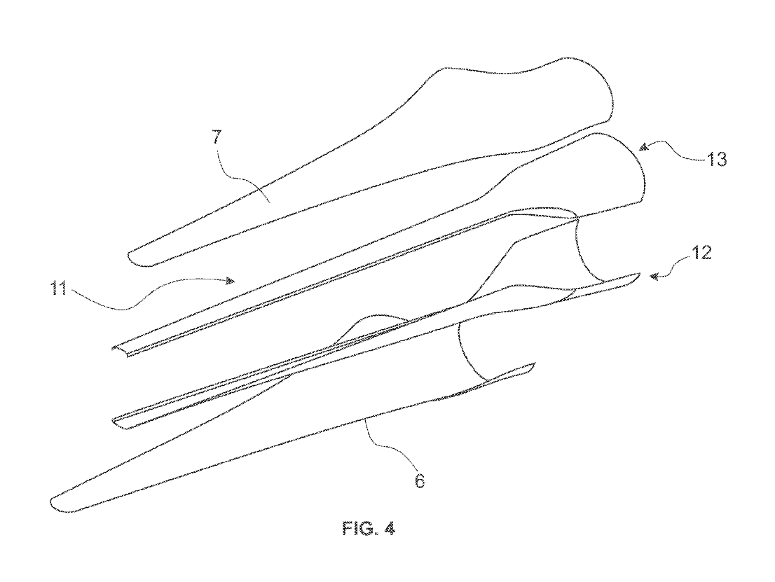

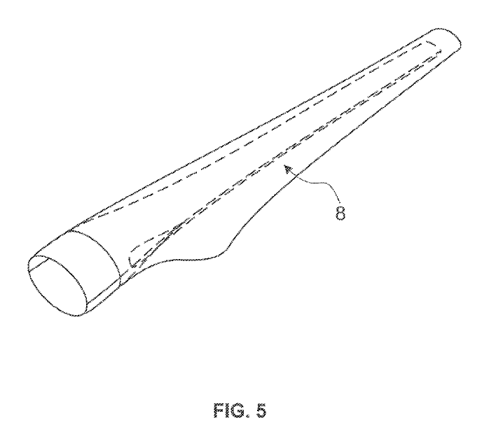

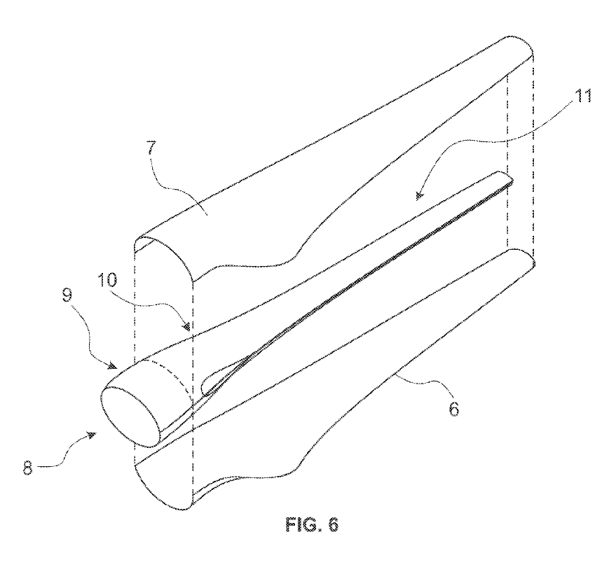

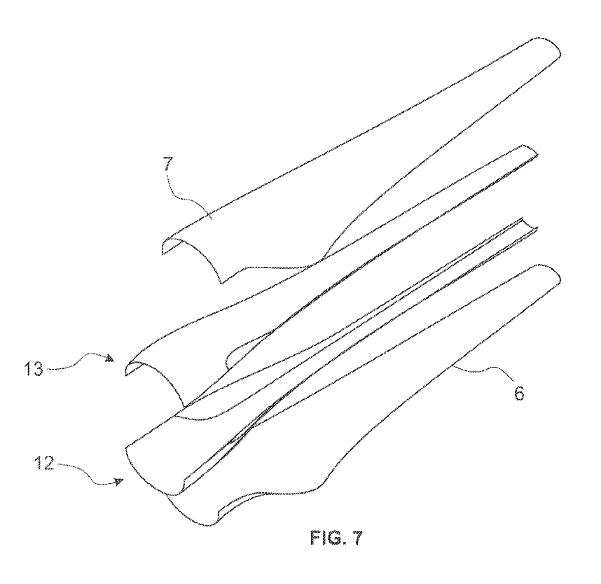

FIGS. 1 to 7 show an exemplary embodiment of the present invention, including perspective views of the blade final shape and exploded views.

One aspect of the invention is directed to an aerogenerator blade (1) comprising an intrados shell (6) also called pressure side, an extrados shell (7), also called suction side, and a structural beam (8). The structural beam (8) comprises a root spar (9), a transitional spar (10) and a box spar (11). The root spar (9) has a substantially circular cross section configured to support the connection of the aerogenerator blade (1) to the aerogenerator hub. The transitional spar (10) tapers from the root spar (9) towards the box spar (11). The box spar (11) tapers towards the blade tip (3). The aerogenerator blade (1) further comprises a first section (12) of the structural beam (8) including at least a root spar (9) portion, a transitional spar (10) portion and a box spar (11) portion, the portions forming a first integral structural beam section (12); a second section (13) of the structural beam (8) including at least the counterparts of the root spar (9) portion, the transitional spar (10) portion and the box spar (11) portion, said counterpart portions forming a second integral structural beam section (13). The first section (12) of the structural beam (8) is joined with the second section (13) of the structural beam (8), forming the structural beam (8). The intrados shell (6) and the extrados shell (7) are assembled on the structural beam (8).

The box spar (11) portion may be manufactured having one section with an ‘L’ shape and the other section with the counterpart shape, corresponding to an inverted ‘L’, which results in a typical box spar configuration. Alternatively, the box spar (11) sections may be manufactured having one section with an ‘U’ shape and the other section with the counterpart shape, corresponding to a spar cap shape, resulting in another typical box spar configuration. Each section of the transitional spar (10) portion may also be manufactured with different shapes that mutually correspond to the final shape of the transitional spar (10). Each section of the root spar (9) portion may also be manufactured with different shapes that mutually correspond to the final shape of the root spar (9). Although the root spar (9) is described herein as having a substantial circular cross section, another cross section profiles may also be possible and will depend upon the particular aerodynamic profile of the blade and the blade to hub connection configuration. For instance, the root spar (9) may have a circular, an oblong, an oval or other suitable cross section.

The intrados shell (6) and the extrados shell (7) may completely cover the structural beam (8) span length, including all the box spar (11), the transitional spar (10) and the root spar (9). As the root spar (9) of the structural beam (8) is already a structural member of the blade, having the structural strength necessary for supporting the loads for providing the connection to the aerogenerator hub, usually it will not be necessary that the intrados shell (6) and extrados shell (7) cover the entire length of the root spar (9). Alternatively, the intrados shell (6) and extrados shell (7) may cover only the box spar (11) and the transitional spar (10) or a substantial part of the transitional spar (10). Other suitable designs and combinations may be possible according the aerodynamic design of the blade. In some cases it may be desirable to laminate additional layers of materials in the internal and external surface of the root spar (9), for instance, for obtaining an additional thickness for inserting the fasteners such as studs. According to the particular requirements of each design, it may be necessary to laminate layers of material for guaranteeing the joining between the intrados and extrados shell, and for guaranteeing the joining of the two sections of the structural beam, wherein said layers may extend along the entire length of the said components or only in part of said length.

Another aspect of the invention is directed to a method of manufacturing an aerogenerator blade (1), the aerogenerator blade (1) comprising an intrados shell (6), an extrados shell (7) and a structural beam (8), the structural beam (8) comprising a root spar (9), a transitional spar (10) and a box spar (11), wherein a) the root spar (9) has a substantially circular cross section configured to support the connection of the aerogenerator blade (1) to the aerogenerator hub; b) the transitional spar (10) tapers from the root spar (9) towards the box spar (11); and c) the box spar (11) tapers towards the blade tip (3).

The method comprises manufacturing a first section (12) of the structural beam (8) in a first mould, the first section (12) including at least a root spar (9) portion, a transitional spar (10) portion and a box spar (11) portion, the portions forming an integral first section (12) of the structural beam (8); manufacturing a second section (13) of the structural beam (8) in a second mould, the second section (13) including at least the counterparts of the root spar (9) portion, the transitional spar (10) portion and the box spar (11) portion, said counterpart portions forming an integral second section (13) of the structural beam (8); joining the first section (12) of the structural beam (8) to the second section (13) of the structural beam (8), forming the structural beam (8); and assembling the intrados shell (6) and the extrados shell (7) on the structural beam (8).

Manufacturing a typical aerogenerator blade further includes a plurality of other steps and procedures that are not described herein in detail, being well known for a person skilled in the art. For instance, manufacturing a typical aerogenerator blade usually include steps related to painting, installing additional devices such as a root bulkhead, lighting systems, and other steps according the particular type of the blade. While the invention has been disclosed by this specification, including its accompanying drawings and examples, various equivalents, modifications and improvements will be apparent to the person skilled in the art. Such equivalents, modifications and improvements are also intended to be encompassed by the following claims.

1. An aerogenerator blade comprising an intrados shell, an extrados shell and a structural beam, the structural beam comprising a root spar, a transitional spar and a box spar, wherein
a) the root spar has a substantially circular cross section configured to support the connection of the aerogenerator blade to the aerogenerator hub;
b) the transitional spar tapers from the root spar towards the box spar; and
c) the box spar tapers towards the blade tip; and
wherein the aerogenerator blade is characterized by comprising:
a first section of the structural beam including at least a root spar portion, a transitional spar portion and a box spar portion, the portions forming a first integral structural beam section;
a second section including at least the counterparts of the root spar portion, the transitional spar portion and the box spar portion, said counterpart portions forming a second integral structural beam section;
and wherein the first section of the structural beam is joined with the second section of the structural beam, forming the structural beam;
and the intrados shell and the extrados shell are assembled on the structural beam.

2. An aerogenerator blade according to claim 1, wherein the intrados shell and the extrados shell cover the entire length of the box spar, at least a part of the transitional spar and at least part of the root spar.

3. Method of manufacturing an aerogenerator blade, the aerogenerator blade comprising an intrados shell, an extrados shell and a structural beam, the structural beam comprising a root spar, a transitional spar and a box spar, wherein
a) the root spar has a substantially circular cross section configured to support the connection of the aerogenerator blade to the aerogenerator hub;
b) the transitional spar tapers from the root spar towards the box spar; and
c) the box spar tapers towards the blade tip;
wherein the method is characterized by comprising:
manufacturing a first section of the structural beam in a first mould, the first section including at least a root spar portion, a transitional spar portion and a box spar portion, the portions forming a first integral structural beam section;
manufacturing a second section of the structural beam in a second mould, the second section including at least the counterparts of the root spar portion, the transitional spar portion and the box spar portion, said counterpart portions forming a second integral structural beam section;
joining the first section of the structural beam to the second section of the structural beam, forming the structural beam;
assembling the intrados shell and the extrados shell on the structural beam.
